(19) United States
(12) Patent Application Publication
(10) Pub. No.: US 2009/0184196 A1
(43) Pub. Date: Jul. 23, 2009

(54) WIDE AREA AERIAL CRANE SYSTEM

(76) Inventor: Andrew John Price, Hope (CA)

Correspondence Address: Andrew John Price, PO Box 399, Hope, BC, V0X1L0, CA

(21) Appl. No.: 12/358,236

(22) Filed: Jan. 22, 2009

Related U.S. Application Data
(60) Provisional application No. 61/011,555, filed on Jan. 22, 2008.

(51) Int. Cl. B64B 1/50; B65H 75/00; B66D 3/04

(52) U.S. Cl. 244/33; 242/370; 254/390

(57) ABSTRACT

A tether-based system for utilizing the aerostatic lift of a light-than-air balloon for the transport of payload across a wide area without having to translate the balloon along with the payload.

### CROSS-REFERENCE TO RELATED APPLICATIONS

The present application claims priority from U.S. Patent Application Ser. No. U.S. 61/011,555 filed Jan. 22, 2008.

### FIELD OF THE INVENTION

The present application relates to the field of lifting machinery.

### BACKGROUND OF THE INVENTION

Machinery for lifting and transporting objects dates back to ancient times, as various crane-like devices were an indispensable part of any construction project. As people mastered the art of flying, they soon realized that aerial devices can be used to lift cargo. An aerial crane is therefore a lifting device that does not directly transfer the weight of the lifted objects to the ground, but rather to the atmosphere around itself. Both lighter-than-air (balloons) and heavier-than-air (helicopters) devices are used today as aerial cranes.

In addition to not transferring their load to the ground, aerial cranes also offer a practically infinite coverage area, since they can literally pick up their load and fly away. Balloons that are tethered to the ground are often referred to as Aerostats. Aerostats offer a limited coverage area, though still much larger than that is offered by ground-based cranes.

This application is based on such a tethered balloon, or aerostat, arrangement.

In U.S. Pat. No. 5,080,302, a multiply-tethered aerostat is described in which control of the length of the individual tethers is used to locate the balloon relative to the ground. A lift line is then used to carry the loads, which must of course be lighter than the buoyancy offered by the balloon.

Such a system is illustrated in FIG. 1. An apex (12) is anchored to 3 spooling anchors (14a-c) using 3 mainstays (13a-c). A balloon (10) pulls up on the apex through a balloon line (11). A lift line (16) connects the apex to a payload hook (19).

It is important to note that the lift line is principally vertical, and in order to move the payload hook in a horizontal direction, the balloon has to be moved. This is a serious drawback, since the balloon experiences relatively large aerodynamic drag forces, the direction of wind will reflect on the position of the load hook due to the fact that the mainstays have some flexibility, which is amplified by their considerable length.

Also, the relatively steep angle of the mainstays does not allow fast motion of the balloon, and the considerable length of the lift line cause very long-period swinging of the payload, which takes a long time to die out.

Vertical motion of the payload hook is achieved either by moving the balloon up and down, or by controlling the length of the lift line, for example by adding a winch at the apex.

Mathematically, if 3 mainstays are used, connected to different anchor points on the ground, and if positive tension is maintained in all of them, the position of the balloon is well defined. If any of the mainstays goes slack, however, control of the position of the balloon is lost.

Obviously, any load carried by the balloon decreases the tension in the mainstays. Additionally, in the face of wind, tension in any down-wind mainstays also decreases. The wider the distance between the anchor points, the higher the tension in the mainstays, and the more wind the structure can accommodate before going slack.

When attempting to design a multiply tethered balloon system, the operator is therefore faced with a trade-off. The baseline needs to be as wide as possible to offer better control of the balloon, but the increased tension quickly requires much thicker and heavier mainstays.

Finally, the large mass and surface-area of the balloon make it very difficult to precisely and nimbly control its position.

### SUMMARY OF THE INVENTION

In the present application, a system is described for lifting and transporting payloads using a tethered balloon. In the description the words “line” and “tether” are interchangeable, though we often use “line” when indicating a specific named tether. (E.g. “lift line”)

The system is described in FIG. 2. A lighter-than-air balloon (20) lifts an apex object (22) through a balloon line (21). A set of mainstay lines (23a-c) connect the apex to a set of ground based anchors (24a-c), which are capable of independently spooling the mainstays in and out, thereby controlling the position of the apex in space. A lift line (26) drops from the apex to a hub (27) whose position is controlled by three move lines (25a-c) that are similarly spooled at the anchors. A hoist line (28) drops down from the hub to a payload hook (29).

It is important to note that the position of the apex and the position of the hub are controlled independently, so the lift line is generally not vertical. The balloon can remain relatively stationary and at high altitude, while the hub can be moved around much faster than the relatively sluggish balloon.

The non-vertical lift-line results in a corresponding force component on the move lines, so moving the hub encounters principally the resistance of the inertia of the payload, but none of the inertia or aerodynamic drag of the balloon. Vertical motion of the payload hook is achieved through vertical motion of the balloon, or through control of the length of the lift line or hoist line at any point along their length.

The novelty of this system is in the introduction of a new tether geometry in which the position of the lift point (the apex) is controlled independently of the position of the payload point (the hub). The utility of this system is in allowing fast, precise and nimble positioning of the hub, while allowing the balloon to loiter relatively stationary at high altitude, allowing a wide coverage area and avoiding low-altitude shifting winds.

The system is non-obvious since unlike other aerial crane arrangements, the load is intentionally placed not under the balloon or helicopter which generate the lift.

### DESCRIPTION OF THE DRAWINGS

FIG. 1 depicts existing art—a pyramid tethered balloon with lift line.

FIG. 2 depicts a pyramid tethered balloon with lift line, hub, and move lines.

FIG. 3 depicts a partial side view showing independent anchor spools.

FIG. 4 depicts a partial side view showing mainstay borne move-sheave

FIG. 5 depicts a partial side view showing hub mounted lift winch

FIG. 6 depicts a partial side view showing apex mounted lift winch

FIG. 7 depicts a 3D view of system with ground-winched apex mounted lift line

FIG. 8 depicts a 3D view of system with separate mainstay and move anchors

FIG. 9 depicts a Block diagram of control system

FIG. 10 depicts a system deployment Process

FIG. 11 depicts a wind lean response

FIG. 12 depicts an anchor truck

FIG. 13 depicts an anchor truck line routing

FIG. 14 depicts a zero net power winch

FIG. 15 depicts the components of zero net power winch

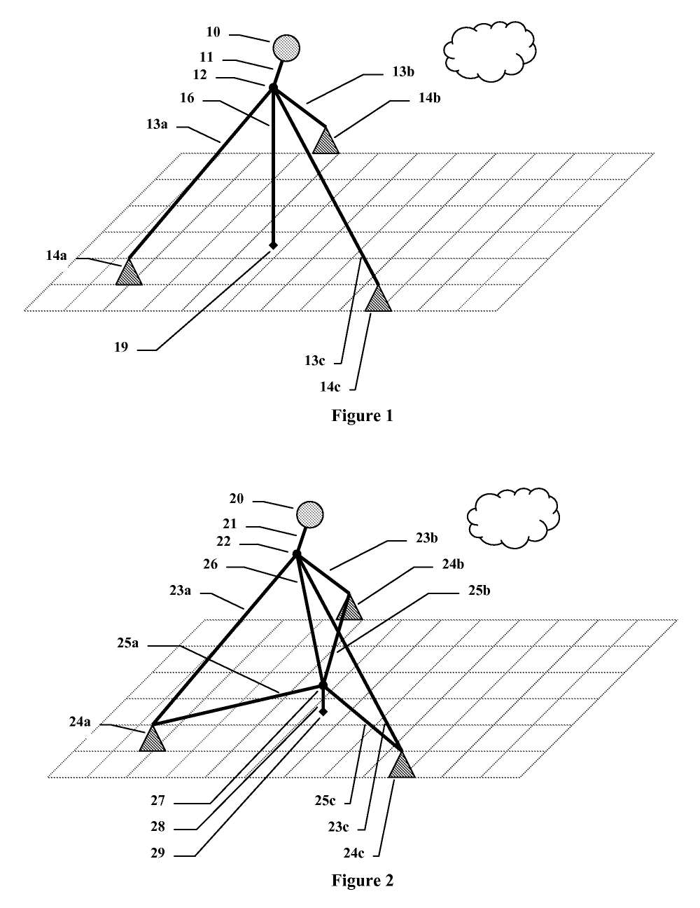

### DETAILED DESCRIPTION OF THE INVENTION

In the present application, a system is described for lifting and transporting payloads using a tethered balloon. In the description the words “line” and “tether” are interchangeable, though we often use “line” when indicating a specific named tether. (E.g. “lift line”)

### Detailed Description—Basic Geometry

The system is described in FIG. 2. A lighter-than-air balloon (20) lifts an apex object (22) through a balloon line (21). A set of mainstay lines (23a-c) connect the apex to a set of ground based anchors (24a-c), which are capable of independently spooling the mainstays in and out, thereby controlling the position of the apex in space. A lift line (26) drops from the apex to a hub (27) whose position is controlled by three move lines (25a-c) that are similarly spooled at the anchors. A hoist line (28) drops down from the hub to a payload hook (29).

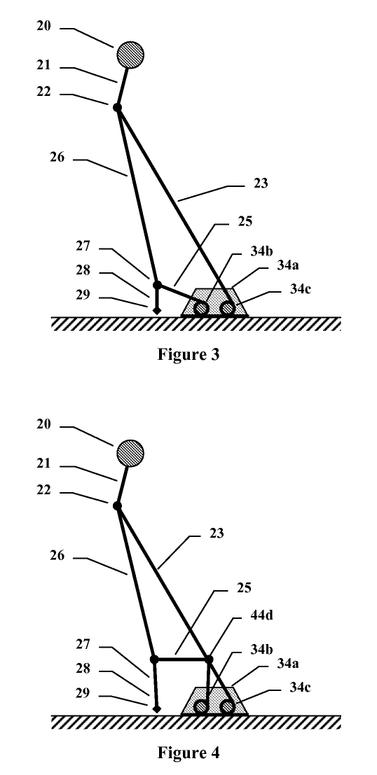

FIG. 3 depicts a single anchor station showing its chassis (34a), the mainstay spool (34c) and the move line spool (34b).

It is important to note that the position of the apex and the position of the hub are controlled independently, so the lift line is generally not vertical. The balloon can remain relatively stationary and at high altitude, while the hub can be moved around much faster than the relatively sluggish balloon.

The non-vertical lift-line results in a corresponding force component on the move lines, so moving the hub encounters principally the resistance of the inertia of the payload, but non of the inertia or aerodynamic drag of the balloon. Vertical motion of the payload hook is achieved through vertical motion of the balloon, or through control of the length of the lift line of hoist line at any point along their length.

We define the adjusted lift of the system as the lift of the balloon less all the weight it is carrying. For a given adjusted lift and wind velocity, we define the critical angle as the angle to the horizontal assumed by a singly-tether balloon system with the same adjusted lift. For our pyramid structure to be stable, its mainstay lines must form an angle to the horizontal which is smaller than the critical angle.

In this application we choose the lift of the balloon so that the critical angle at winds up to 40 MPH exceeds 45 degrees, and choose the nominal geometry to have edges at 45 degrees to the horizontal.

### Detailed Description—Scale

In order be useful, the system must cover an area significantly larger than the span of mechanical cranes. For many applications, such as large construction sites and logging applications, a km-scale area is desirable. The loads the system has to carry are in the 1-10 ton range. When considering km-scale structures at realistic wind speeds, the size of balloon required to maintain adequate overlift is in the order of 50 meters. The tensions in the mainstays can become larger than the payload, and requires the use of high-strength low-weight materials such as Spectra (Manufactured by Honeywell Inc. of Morristown, N.J.), Zylon (Manufactured by Toyobo of Japan), Kevlar (manufactured by DuPont of Wilmington, Del.), or Dyneema (Manufactured by DSM of Geleen, the Netherlands). If somewhat smaller scaled, steel wire can also be used. Other high strength materials such as carbon fibers can also be used.

The system described here is designed to handle 4 ton payloads, over an area 2-3 km across. The balloon has a lift force of 60 tons, and is maintained at approximately 1.5 km altitude. Three anchor stations are used, located approximately three km apart. The cables used are 1″ diameter Spectra lines.

Balloons of this scale are available from vendors such as Lindstrand Technologies of Oswestry Shropshire, UK. Advanced ropes can be purchased from Puget Sound Ropes of Seattle, Wash. Advanced winches can be purchased from Markey Machinery of Seattle, Wash.

Other system sizes and configurations are obviously possible.

### Detailed Description—Vertical Motion

Vertical motion of the payload hook is achieved through adjustment of the lengths of the mainstays at the anchor winches. As the balloon is allowed to rise or is pulled down, the entire structure adjusts up and down.

It is worth noting that while in general raising the payload takes energy and lowering it pays energy, since the lift of the balloon is larger than the weight of the payload, the situation here is revered. This reversal in trends enable more sophisticated and energy efficient methods for vertical motion, described under alternative embodiments below.

### Detailed Description—Horizontal Motion

Horizontal motion of the payload hook is achieved through adjustment of the lengths of the move lines at the anchor winches.

In all but the vertical position, the load line imparts a force component on the move lines. As it moves away from the center point, the hub also experiences a vertical component of motion.

### Detailed Description—Control

The control of the crane is achieved though a two-tiered system. A high-level command processor determines the desired position of the payload hook based on input from operators, safety envelopes, terrain layout, pre-programmed locations, etc. The position command is then transferred to a low-level control system that commands the winches to move in order to bring the payload hook to the desired position, bringing into account inputs from various sensors about the current state of the system and environmental factors such as wind.

Operator commands to the command unit can be high level, and include:

Bring payload hook to me.

Send payload to pre-programmed point A.

Enable position commands from Joystick A.

Position commands issued by the command unit to the control unit are simply target coordinates in 3-D, plus maximum velocity and acceleration values that the payload should not exceed. In many cases it takes several position commands to describe a complete point-to-point motion.

System inputs to the control units include:

Position sensors (e.g. GPS, Radar altimeter) on the various components

Wind velocity and direction sensors.

Tension sensors (e.g. strain gauges) on the anchors and tether ends.

Line angle sensors at tether ends.

Tether-out sensors on the winches.

The outputs from the control unit to the spools are simply spool-in/spool-out position or velocity commands.

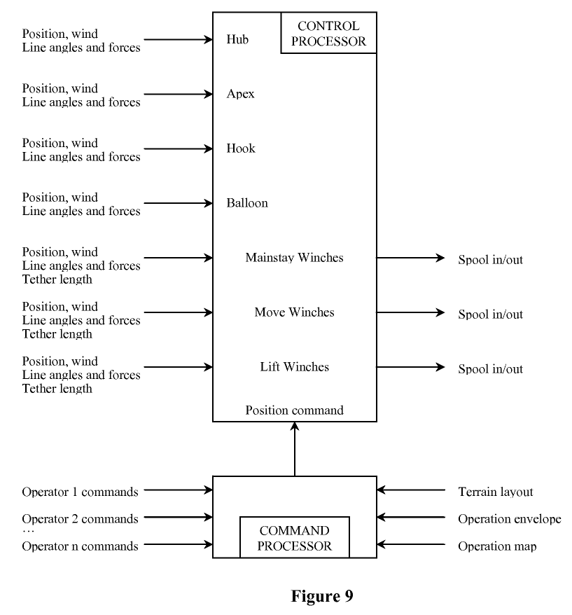

FIG. 9 shows a block diagram of the command and control device, and the signals they handle.

It should be noted that active control of a hook at the bottom of a tether is existing art, used in some crane and helicopter applications. It is assumed that such technology is incorporated into the hub control loop, though this is not a requirement and not part of this application.

### Detailed Description—Deployment

When erecting the crane, the position of the balloon must be controlled at all times. Slack in any of the lines, when coupled with shifting winds, can result in the balloon traveling uncontrollably away from one of the slack lines. When the slacked line tightens, inertia-caused loads are significantly higher than the steady-state loads caused, for example, by wind.

To avoid such a situation, we describe a deployment procedure which maintains control of the balloon at all times. In this procedure, all but one of the Mainstay spools are mounted on vehicles such as trucks or boats. For reasons of safety, the anchors should weigh significantly more than the breaking force of the lines, thus preventing the possibility of a vehicle being hoisted into the sky. In this embodiment, we use flat-bed trucks loaded to weigh 60 tons each, using steel plates as the dead weight.

Step 1—Setup: The procedure starts by locating the anchors 30 meters from each other—comparable to the diameter of the balloon. All three Mainstay lines are connected to the trucks, and are initially slacked.

Step 2—Inflation: The balloon is inflated, and is allowed to float until the apex is at a height of 30 m, controlled by the central lift line. At this point the system is still not fully controlled, but the amplitude of motion of the apex is small. We now winch in the mainstay lines and establish the pyramid, thus gaining control of the apex. We now have a very small pyramid, but with correct line angles.

Step 3—Expansion: From this point onwards, the pyramid is always preserved, in that the angles of the lines (the edges of the pyramid) are maintained within a 5-degree deviation from the nominal geometry. The trucks winch out mainstay line until the mainstays reach the upper angle limit (50 degrees to the horizontal) and then drive away from each other until the mainstays reach the lower angle limit (40 degrees to the horizontal). This step is repeated until the pyramid reaches its final size.

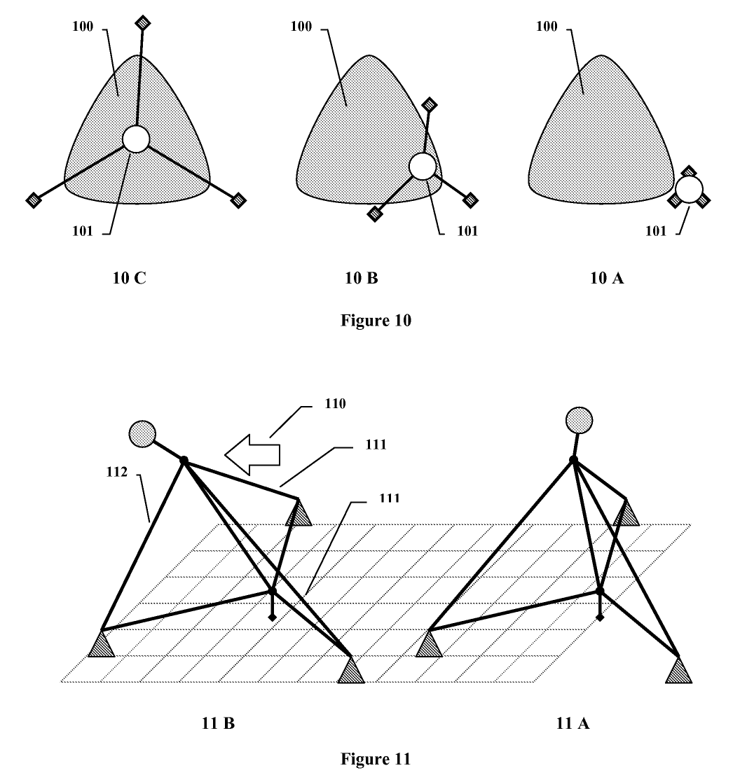

FIG. 10 (a through c) shows how the balloon (101) is moved to the center of the work area (100) while being kept at the center of the three anchors. The bottom left anchor is fixed, while the other two move from their initial deployment position (FIG. 10a) to their final working positions (FIG. 10c)

When un-deploying the system, the exact reverse procedure is followed, again keeping the pyramid edges within the boundaries of the specified angles until all anchors are in close proximity and the balloon is almost at ground height and can be captured, deflated, and stowed.

### Detailed Description—Mobile Anchor Structure

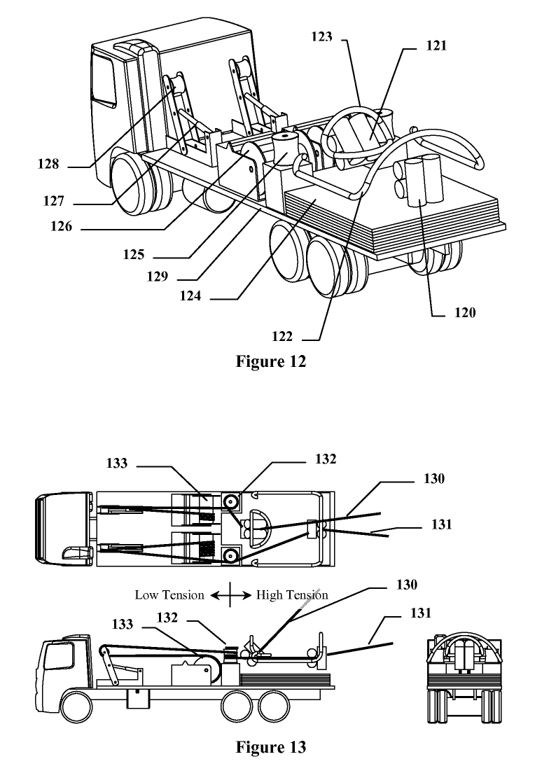

FIG. 12 depicts a mobile anchor truck, handling both a Mainstay and a Moveline line. The lines first enter their respective fairleads (121, 120) which allow each line to be accepted from a wide range of angles. (Fairleads are a common element in maritime riggings, for example). Railings (123, 122) prevent the lines from snagging if they become slack. Each line is then routed to its powered capstan (125) which controls its position. Each line is then routed through a tensioner comprised of a roller on a tension arm (128) pushed by a gas spring, and to a spool drum (126). The truck (129) is weighted down by a set of weights (124). The lines are not shown in this diagram.

FIG. 13 shows the Mainstay line (130) and Moveline (131) on the anchor from orthogonal views. The portion of each line between the capstans (132) and the spools (133) is in low tension, whereas the portion of the line outwards of the capstan is in high tension.

While a mobile anchor provide many advantages for short-term deployment, permanent anchors may also be used.

### Detailed Description—Wind Lean Response

As explained above, the crane is able to fully control the balloon as long as all lines are taut. In the face of wind, tension decreases in downwind lines, until a point is reached where the tension is zero, and the balloon begins to travel and is no longer fully controlled.

To increase the level of wind that the crane can operate in, we describe a procedure for adjusting the shape of the structure in response to wind.

When a wind is blowing from a certain direction, we move the apex in the down-wind direction, so up-wind mainstays become more horizontal, and downwind mainstays become more vertical. This reduces the tension in the upwind mainstays and increases the tension in the downwind mainstays.

FIG. 11a shows the crane under minimal wind conditions. FIG. 11b shows the crane when responding to wind in the direction shown (110). The upwind mainstays (111) are winched out, whereas the downwind ones (112) are winched in. The direction and magnitude of the wind are indicated by the slope of the balloon line.

This procedure moves the balloon from its optimal location at the center of the work area, and so can increase the angle of the lift line and therefore the forces in the move lines. The amount of lean we can introduce in response to wind is therefore limited.

Note that the balloon line also isolates the system from fast changes in the wind direction.

### Alternate Embodiment—Multiple Legs

In this embodiment, more than 3 mainstays are used. While it takes a minimum of 3 mainstays to fix the location of the balloon, more mainstays and move lines can be used, increasing the coverage area.

### Alternate Embodiment—Mainstay-Borne Sheaves

FIG. 4 depicts a different embodiment in which the move line is routed through a mainstay-borne sheave (44d) in order to clear ground obstacles that may be present between the anchor and the hub. This arrangement also allows for a taller placement of the hub.

### Alternate Embodiment—Pulleys and Pulley Blocks

In another embodiment, as is common-practice in lifting devices, some tethers can be implements using pulley blocks and multiple passes of a single physical tether, resulting in an “n-up” logical tether that carries n times as much load as the physical line tension, but requires n times the spooling distance. When using an extra pulley at an anchor, it is also possible to separate the physical position of the spool mechanism from the physical location of the anchor.

### Alternate Embodiment—Hub Lift-Winch

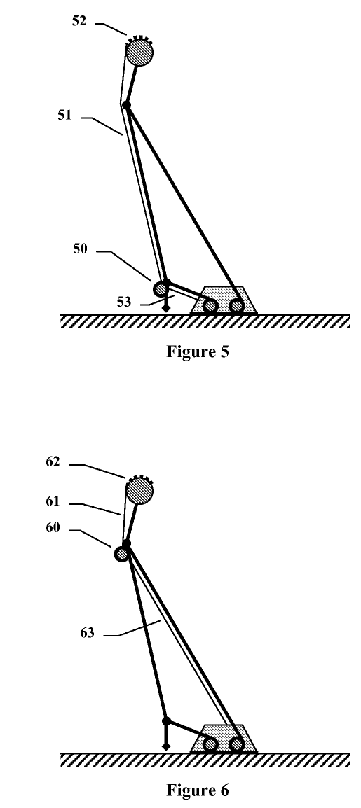

FIG. 5 shows a lift winch (50) located at the hub. Power to this lift winch is provided from a combination of solar panels (52) mounted at the top of the balloon and ground supply, through a electric cables (51,53) embedded in the structural cable. Such a winch represents added mass that the move lines have to move.

### Alternate Embodiment—Apex Lift-Winch

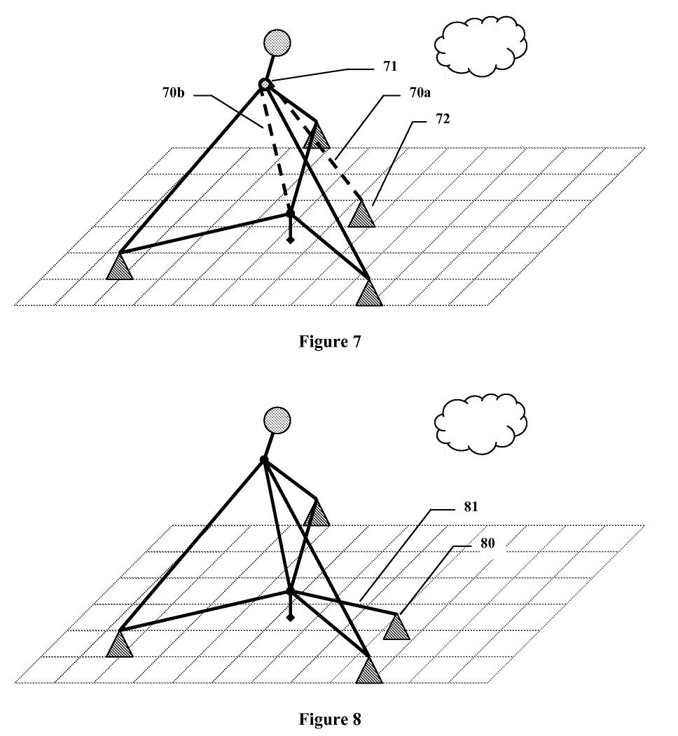

FIG. 6 shows a lift winch (60) located at the apex. Power to this lift winch is provided from a combination of solar panels (62) mounted at the top of the balloon and from the ground through electric cables (61,63) running with the structural cables. An apex mounted lift winch does not have to be moved by the move lines, but it does require the move lines to accommodate the resulting vertical motion of the hub. In addition, the apex mounted lift winch has to raise and lower the additional weight of the hub and half the weight of the move lines.

### Alternate Embodiment—Buoyancy Energy Storage

In this embodiment, an additional winch at the apex works the balloon line and uses it as an energy storage device, using buoyancy potential energy, which is essentially the opposite of gravitational potential energy, since the balloon stores mechanical energy when pulled in. The balloon line winch and lift line winch are connected through a variable ratio transmission.

When raising the lift line, the apex winch powers itself by releasing an appropriate amount of balloon line. When lowering the lift line, the apex wince stored energy by channeling the mechanical power into pulling the balloon line back in. The transmission ratio is kept around the reciprocal of the tension ratio between the balloon line and the lift line. If the transmission ratio is above this value, the payload line will naturally sink, pulling the balloon down. If the transmission ratio is below this value, the payload line will naturally rise.

This “Zero Net Power” winch therefore requires only enough power to compensate for inefficiencies in the drive train, and the potential gravitational energy change in the payloads that are being moved. If the payloads consistently lose potential energy, as in the case of moving tress off of a mountain, the winch may not require any external energy at all.

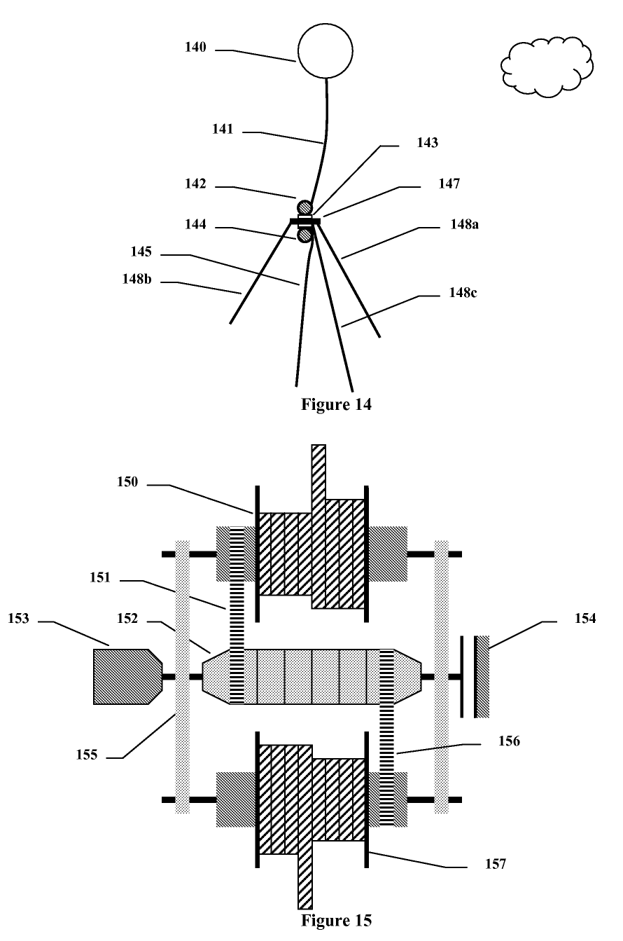

FIG. 14 describes the structure of such a Zero Net Power winch. The balloon (140) is connected through the balloon line (141) to the balloon-side spool (142). The lift line (145) is connected to the lift-side spool (144). The two spools are connected to each other through a variable transmission (143) which can be mechanical, electrical, or hydraulic. The transmission is connected to the apex structure (147) which is connected to the mainstays (148 a-c).

FIG. 15 shows the internal composition of the Zero Net Power winch. A balloon-side line spool (150) is connected through a power belt (151) to a variable rate transmission (152), which is connected by a second belt (156) to a lift-line spool (157). The transmission is also connected to a motor (153) and brake (154). The entire winch is connected to the apex structure (155).

Repeated application of this cycle for raising and lowering payload cause the balloon line to eventually spool all the way out, since for a single payload raising and lowering, it rises a bit more than it sinks. This represents the depletion of the stored energy, and so the transmission unit also contains a motor which is used to restore energy to the system by winching the balloon line back in.

However, the following “Buoyancy Potential Transfer” procedure can be used to winch in the balloon without using a motor at the apex. When not carrying payload, the Mainstay winches pull the entire structure down, thus expending a certain amount of energy and storing it as buoyancy energy. They empty lift line is hoisted up by the same amount, requiring a very small amount of energy. The crane then picks up a payload and raises it by releasing mainstay line, without moving the apex winch at all. The Mainstay winches release the same amount of tether back out, but because of the payload, they get back less energy—the difference is stored as potential payload energy. The crane now lowers the payload using the apex winch, winding the balloon back in. The balloon buoyancy energy storage system is thus charged, at the expense of work done by the anchor winches.

### Alternate Embodiment—Ground Lift-Winch

FIG. 7 shows a geometry in which the lift line (70a,b) is routed through a pulley (71) at the apex and is spooled at a lift winch anchor on the ground (72). Small vertical motions are controlled entirely from the lift winch anchor. For large motions, the mainstays are used to raise or lower the balloon. When the balloon rises, the payload rises at twice the rate. The energy input into the system is the difference between the energy the payload gains and the energy the balloon loses.

This system is not as energy efficient as the apex winch, but has the advantage that much like in the first embodiment it does not require winches that are not located on the ground.

### Alternate Embodiment—Separate Anchors

FIG. 8 shows an addition move-line (81) and anchor point (80). While the first embodiment groups the mainstay and move winches together, in many cases it is advantageous to have more move anchors and move lines separate than the mainstays. This is the case, for example, when placing a move line anchor near a frequent payload drop-of/pick-up location.

### Alternate Embodiment—Single Mainstay Deployment

In this embodiment, the balloon is deployed to height using a single mainstay, while the other two mainstays are connected to it but are kept slack. The balloon's position is therefore uncontrolled.

After reaching working altitude, the other mainstays are carried over to their final working locations, which still slack. Once in position, they are winched in, and the pyramid is formed.

The advantage of this method is that it does not require movable anchors, and can handle bridges, power lines, and other overhead obstructions on the route from the initial inflation point to the final work locations of the anchors.

The difficulty of this method is that the pyramid is not stable throughout the deployment process, and so the carriers of the mainstays must be prepared to handle the extra cable or sudden pulls that may result from the balloon shifting position at altitude.

Un-deployment can be accomplished by reversing the procedure, first releasing all mainstays but one, then bringing the slacked mainstays to the anchor of the last remaining mainstay, and then winching the balloon down and capturing it.

### Alternate Embodiment—Double Mainstay Deployment

In this embodiment, two mainstays are initially laid on the ground, leading from two “pivot” anchors to a “main” anchor. The balloon is inflated over the main anchor, and the main anchor mainstay is slowly extended. As a result, the two pivot mainstays rotate around the axis connecting the two pivot anchors. The process is stopped once a stable pyramid is formed.

### Operation

The crane is used for moving objects. Erection of the system is described under the “deployment” sections above. After the system is deployed, the Command and Control system described above is used to command the winch motors based on the user's commands. The system can be un-deployed by reversing a deployment procedure, and the re-deployed to a different location.

### CONCLUSION

We have shown a novel geometry that allows a balloon borne payload hook to be maneuvered quickly and precisely without having to move the balloon with it, using an additional set of tethers that positions the bottom of the lift line independently of its top.

This system allows transport of payloads over a wide area (as delineated by the anchor locations) quickly and cheaply, and without requiring a physical footprint within the area covered by the crane.

We have shown how the lifting winch can be operated without requiring an active power system at the apex.

We have shown how the system is deployed to its operational state, and how operations are commanded and controlled.

What is claimed is:

1. An aerial crane system consisting of:
a lift-line tether, having a top end called the apex and a bottom end called the hub,
a lighter-than-air device called the balloon that pulls upwards on the apex,
a means of holding payload called the payload hook that is pulled upwards by the hub,
a plurality of mainstay tethers each having an apex end connected to the apex and an anchor end,
one or more move-line tethers each having a hub end connected to the hub and an anchor end,
such that the balloon lifts the payload via the lift line, and the hub's position is controlled by the move-line tethers and the apex position is controlled by the mainstay tethers.

2. The device of claim 1, further containing a plurality of surface anchors collectively connected to the anchor ends of the mainstay tethers and the move-line tethers and to the surface underlying the device.

3. The device of claim 2, wherein one or more anchors contains a winch capable of spooling the attached tether upon command, changing its effective length.

4. The device of claim 1, further containing a lift-spool means at the apex for spooling the lift line.

5. The device of claim 4, further containing a balloon-line tether connecting the balloon to the apex.

6. The device of claim 5, further containing a balloon-spool means at the apex for spooling the balloon line.

7. The device of claim 6, further containing a means for transferring power between the lift-spool means and the balloon-spool means called a transmission means.

8. The device of claim 7, wherein the transmission means is further configured to operate as a “Zero Net Power” winch.

9. The device of claim 1, further containing a hoist-line tether connecting the payload hook to the hub.

10. The device of claim 1, further containing a means at the hub capable of spooling the hoist line.

11. The device of claim 1, further containing photovoltaic panels on the balloon and an electrical supply cable that provides power to devices located on any of the lift line, apex, and hub.

12. The device of claim 1, further containing a pulley at the apex and a means for anchoring tether on the ground called the lift anchor, such that the lift-line is routed through the pulley and back down to the lift anchor.

13. The device of claim 12, wherein the lift-line is connected to the lift anchor via a winch.

14. The device of claim 1, further containing a pulley attached to a mainstay so that a move-line tether is routed through said pulley between the move-line anchor and the hub.

15. The device of claim 1, further containing a means for changing the length of the lift-line.

16. The device of claim 1, further containing a means for changing the length of the hoist line.

17. The device of claim 1, where a move-line or mainstay anchor is located on a mobile ground vehicle.

18. The device of claim 1, where a move-line or mainstay anchor is located on a mobile water vehicle.

19. The device of claim 1, where a move-line or mainstay anchor is embedded into the ground.

20. The device of claim 1, where a move-line or mainstay winch is a capstan.

21. The device of claim 1, further containing a sensor that indicates the effective length of a mainstay or move-line tether.

22. The device of claim 1, further containing a sensor that indicates the position of the balloon, apex, hub, or payload hook.

23. The device of claim 1, further containing sensors that indicate the tension of a mainstay or move-line tether.

24. The device of claim 1, where a tether is made out of a group of materials consisting of steel, Spectra, Kevlar, Zylon, and Dyneema.

25. The device of claim 1, where the balloon is filled with a gas consisting of one of the group Helium, Hydrogen, and Helium-Hydrogen mixture.

26. A payload lifting device capable of storing energy consisting of:
a structural frame,
a lighter than air device called the balloon,
a tether connected to the lighter than air device called the balloon line,
a means for adjusting the effective length of the balloon line, connected to the frame, called the balloon line winch,
a means for holding the payload called the payload hook,
a tether connected the payload hook called the payload line,
a means for adjusting the effective length of the payload line, connected to the frame, and called the payload line winch,
a means for constraining the frame in place,
a means for transferring power between the balloon winch to the payload winch called the transmission,
such that changed to the gravitational potential energy is transferred between the payload and the balloon when either of the payload or the balloon height is changed.

27. The device of claim 25 further configured so that the transmission uses a transmission ratio approximately equal to the reciprocal of the ratio between the tensions in the balloon and payload tethers.
